(19) United States
(12) Patent Application Publication
(10) Pub. No.: US 2025/0130135 A1
(43) Pub. Date: Apr. 24, 2025

(54) METHOD AND SYSTEM FOR AUTOMATICALLY ESTIMATING THE REMAINING USEFUL LIFETIME OF AT LEAST ONE OXYGEN BOTTLE IN THE COCKPIT OF AN AIRCRAFT

(71) Applicant: Airbus Operations (S.A.S.), Toulouse (FR)

(72) Inventors: Jeremy PIRARD, Toulouse (FR); Christophe GAGNOLET, Toulouse (FR)

(21) Appl. No.: 18/918,877

(22) Filed: Oct. 17, 2024

(30) Foreign Application Priority Data
Oct. 18, 2023 (FR) 2311280

(51) Int. Cl. G01M 3/32; B64D 45/00

(52) U.S. Cl. CPC G01M 3/32; B64D 45/00

(57) ABSTRACT

A system includes a collecting unit for collecting a current oxygen pressure value of the oxygen bottles, an estimating unit for estimating an average degradation model, an adapting unit for adapting the average degradation model, a generating unit for generating several future degradation scenarios, an estimating unit for estimating, for each of the future degradation scenarios, a remaining useful lifetime, and for generating a remaining useful lifetimes probability distribution, a transmitting unit for transmitting an end-of-lifetime alert signal to an alert device if a remaining useful lifetime of an oxygen bottle is below a predetermined alert threshold.

### TECHNICAL FIELD

The disclosure herein relates to a method and a system for automatically estimating the remaining useful lifetime of at least one oxygen bottle in the cockpit of an aircraft.

### BACKGROUND

It is known that the members of the flight crew (or navigating personnel) of an aircraft, such as a transport airplane, have an oxygen distribution system that makes it possible to supply them with oxygen, notably in the event of depressurization of the aircraft or a release of smoke. This oxygen distribution system comprises, notably, an oxygen mask for each member of the crew, and one or more oxygen bottles capable of supplying these masks with oxygen.

The “Flight Crew Operating Manual” (FCOM) requires this oxygen distribution system of the crew to be tested before each flight of the aircraft. In a normal situation (in the absence of leaks), a slight reduction of the oxygen pressure is observed after each flight in the oxygen bottle or bottles. The test consists in comparing the pressure indicated on the oxygen bottle, which is representative of the quantity of oxygen available, to a minimum threshold value. When this minimum threshold value is reached, either the oxygen bottle or bottles used are filled up or this or these oxygen bottles is or are replaced.

In the context of the disclosure herein, the lifetime (or remaining useful lifetime) of an oxygen bottle is understood to be the time or duration remaining until the moment when the content of the air bottle reaches a level from which a maintenance action must be performed, namely either a replacement of this oxygen bottle (with another oxygen bottle having a sufficient content), or a filling of the oxygen bottle with oxygen to reach a sufficient content.

However, taking only a single threshold value into account to assess the oxygen capacity of the bottle may not help in capturing different degradation behaviours and predicting a degradation in advance.

Various standard solutions are known for trying to remedy this drawback which are not however fully satisfactory, namely in particular:
filtering methods, for example by Kalman filter, which do not capture the long-term variability.
models based on data such as ARMA or neural networks do not take account of the specific technical knowledge (concerning the degradation) to predict an accurate remaining useful lifetime of the health indicator (namely the oxygen pressure in the bottle).

The neural networks need an enormous quantity of training data which are not available and are not easily interpretable.

There is no estimation of the remaining useful lifetime of the oxygen bottle of the crew of the cockpit.

There is therefore a need to find a solution that makes it possible to anticipate maintenance of the oxygen bottle or bottles.

### SUMMARY

The disclosure herein relates to a method for automatically estimating a remaining useful lifetime of at least one oxygen bottle in a cockpit of an aircraft.

According to the disclosure herein, the method comprises at least the following steps implemented for a current flight of the aircraft iteratively for each oxygen bottle:
a collection step, implemented by a collecting unit, for collecting a current oxygen pressure value of the oxygen bottle or bottles and for correcting the current oxygen pressure value in order to obtain a corrected current pressure value,
a first estimation step, implemented by a first estimating unit, for estimating an average degradation model based on pressure values collected and corrected on a fleet comprising a predetermined number of aircraft,
an adaptation step, implemented by an adapting unit, for adapting the average degradation model based on the corrected current pressure value and on oxygen pressure values previously collected and corrected for X preceding flights, X being a predetermined number of flights preceding the current flight,
a generation step, implemented by a generating unit, for generating several future degradation scenarios based on the corrected current pressure value and on the collected and corrected oxygen pressure values of the X preceding flights,
a second estimation step, implemented by a second estimating unit, for estimating, for each of the future degradation scenarios, a remaining useful lifetime, and for generating a remaining useful lifetimes probability distribution based on the remaining useful lifetimes generated for each of the future degradation scenarios,
a first transmission step, implemented by a first transmitting unit, for transmitting an end-of-lifetime alert signal to an alert device to alert an operator if a remaining useful lifetime of one or more oxygen bottles is below an alert threshold predetermined as a function of the remaining useful lifetimes probability distribution.

Thus, by virtue of the disclosure herein, it is possible to automatically determine the remaining useful lifetime of at least one oxygen bottle in the cockpit of an aircraft, by learning the degradation behaviour using past data and proposing a probabilistic assessment of its end of life before maintenance.
In addition, the corrected current pressure value is obtained in the collection step based on the current oxygen pressure value, based on a current temperature outside of the aircraft and a current temperature of the cockpit of the aircraft.
Furthermore, the method comprises a filtering step preceding the adaptation step, implemented by a filtering unit, for filtering the corrected current pressure value and the collected and corrected oxygen pressure values of the X preceding flights and for determining a trend of the oxygen pressure value for the current flight and the X preceding flights.
Moreover, the adaptation step further comprises a computation sub-step, implemented by a computing sub-unit, for calculating a pressure variation for the current flight and for the X preceding flights based on the trend of the oxygen pressure value determined for the current flight and the X preceding flights.
Furthermore, the adaptation step comprises:
   a computation sub-step, implemented by a computing sub-unit, for calculating a current expected pressure value for the current flight and an expected pressure value for the X preceding flights based on the collected and corrected oxygen pressure values determined for the X preceding flights and on pressure variations determined for the X preceding flights,
   a comparison sub-step, implemented by a comparing sub-unit, for determining, for the current flight and for each of the X preceding flights, respectively, a difference between the corrected pressure value and the expected pressure value,
   a compensation sub-step, implemented by a compensating sub-unit, for compensating the corrected current pressure value and the collected and corrected oxygen pressure values determined for the X preceding flights, if the difference determined for the current flight or at least one of the X preceding flights is positive and exceeds a first threshold value, the oxygen pressure values collected and corrected for the X preceding flights being compensated by adding the difference to the oxygen pressure values collected and corrected for the X preceding flights,
      if the difference determined for the current flight or at least one of the X preceding flights is negative and exceeds a second threshold value, the oxygen pressure values collected and corrected for the X preceding flights being compensated by adding the difference to the oxygen pressure values collected and corrected for the X preceding flights.
Advantageously, the method further comprises a second transmission step, implemented by a second transmitting unit, for transmitting a pressure drop alert signal to the alert device if a flight of the aircraft out of the current flight and the X preceding flights has, for its departure airport, the same arrival airport as the flight which precedes it, in the case where the difference determined for the current flight or at least one of the X preceding flights is negative and exceeds a second threshold value.
In addition, the method comprises a third transmission step, implemented by a third transmitting unit, for transmitting a leak alert signal to the alert device, in the case where the difference determined for the current flight or at least one of the X preceding flights is below a third threshold value.
The disclosure herein also relates to a system for automatically estimating a remaining useful lifetime of at least one oxygen bottle in a cockpit of an aircraft.
According to the disclosure herein, the system comprises at least:
   a collecting unit, configured to collect a current oxygen pressure value of the oxygen bottle or bottles and to correct the current oxygen pressure value in order to obtain a corrected current pressure value,
   a first estimating unit, configured to estimate an average degradation model based on pressure values collected and corrected on a fleet comprising a predetermined number of aircraft,
   an adapting unit, configured to adapt the average degradation model based on the corrected current pressure value and on oxygen pressure values collected and corrected for X preceding flights, X being a predetermined number of flights preceding the current flight,
   a generating unit, configured to generate several future degradation scenarios based on the corrected current pressure value and on the collected and corrected oxygen pressure values of the X preceding flights,
   a second estimating unit, configured to estimate, for each of the future degradation scenarios, a remaining useful lifetime, and to generate a remaining useful lifetimes probability distribution based on the remaining useful lifetimes generated for each of the future degradation scenarios,
   a first transmitting unit, configured to transmit an end-of-lifetime alert signal to an alert device to alert an operator if a remaining useful lifetime of one or more oxygen bottles is below an alert threshold predetermined as a function of the remaining useful lifetimes probability distribution.
In addition, the corrected current pressure value is obtained by the collecting unit based on the current oxygen pressure value, on a current temperature outside of the aircraft and a current temperature of the cockpit of the aircraft.
Furthermore, the system comprises a filtering unit, configured to filter the corrected current pressure value and the collected and corrected oxygen pressure values of the X preceding flights and to determine a trend of the oxygen pressure value for the current flight and the X preceding flights.
Moreover, the adapting unit further comprises a computing sub-unit, configured to calculate a pressure variation for the current flight and for the X preceding flights based on the trend of the oxygen pressure value determined for the current flight and the X preceding flights.
Furthermore, the adapting unit comprises:
   a determining sub-unit, configured to determine a current expected pressure value for the current flight and an expected pressure value for the X preceding flights based on the collected and corrected oxygen pressure values determined for the X preceding flights and on pressure variations determined for the X preceding flights,
   a comparing sub-unit, configured to determine, for the current flight and for each of the X preceding flights, respectively, a difference between the corrected pressure value and the expected pressure value,
   a compensating sub-unit, configured to compensate the corrected current pressure value and the collected and corrected oxygen pressure values determined for the X preceding flights,
   if the difference determined for the current flight or at least one of the X preceding flights is positive and exceeds a first threshold value, the oxygen pressure values collected and corrected for the X preceding flights being compensated by adding the difference to the oxygen pressure values collected and corrected for the X preceding flights,
   if the difference determined for the current flight or at least one of the X preceding flights is negative and exceeds a second threshold value, the oxygen pressure values collected and corrected for the X preceding flights being compensated by adding the difference to the oxygen pressure values collected and corrected for the X preceding flights.
Advantageously, the system further comprises a second transmitting unit, configured to transmit a pressure drop alert signal to the alert device if a flight of the aircraft out of the current flight and the X preceding flights has, for its departure airport, the same arrival airport as the flight which precedes it, in the case where the difference determined for the current flight or at least one of the X preceding flights is negative and exceeds a second threshold value.
In addition, the system comprises a third transmitting unit, configured to transmit a leak alert signal to the alert device, in the case where the difference determined for the current flight or at least one of the X preceding flights is below a third threshold value.
The disclosure herein also relates to an aircraft, such as a transport airplane, comprising a system for automatically estimating a remaining useful lifetime of at least one oxygen bottle in a cockpit of an aircraft, such as that specified above.

### BRIEF DESCRIPTION OF THE DRAWINGS

The attached figures will give a good understanding as to how the disclosure herein can be realized. In these figures, identical references denote similar elements.

FIG. 1 is a schematic representation of the estimation system according to an embodiment;

FIG. 2 is a schematic representation of the estimation method according to an embodiment;

FIG. 3 represents an aircraft embedding the estimation system;

FIG. 4 is a graph representing curves corresponding to future degradation scenarios;

FIG. 5 represents an example of remaining useful lifetimes probability distribution;

FIG. 6 represents a graph in which the oxygen pressure values are compensated after an oxygen bottle has been filled; and

FIG. 7 represents a graph in which the oxygen pressure values are compensated after a pressure drop in the oxygen bottle.

### DETAILED DESCRIPTION

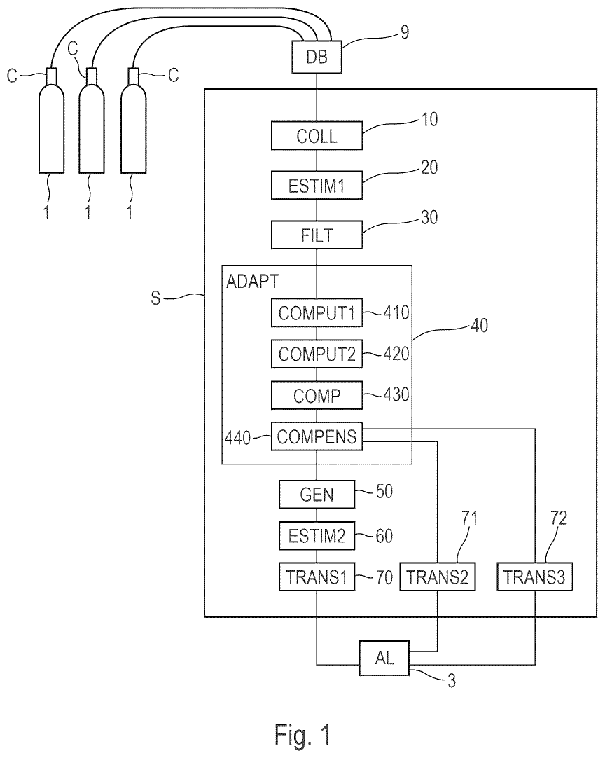

A system S such as that represented in a particular embodiment in FIG. 1 is intended to automatically estimate a remaining useful lifetime of at least one oxygen bottle 1 in a cockpit 2 of an aircraft AC.

The system S can be embedded on board an aircraft, notably a transport airplane (FIG. 3).

The system comprises at least:
a collecting unit 10 COLL (COLL pour “collecting unit”),
a first estimating unit 20 ESTIM1 (ESTIM for “estimating unit”),
an adapting unit 40 ADAPT (ADAPT for “adapting unit”),
a generating unit 50 GEN (GEN for “generating unit”),
a second estimating unit 60 ESTIM2 and
a first transmitting unit 70 TRANS1 (TRANS for “transmitting unit”).

These units are implemented by a computer, such as an avionics computer.

The collecting unit 10 is configured to collect a current oxygen pressure value P_{oxy} (in bar) of the oxygen bottle or bottles 1 and to correct the current oxygen pressure value P_{oxy} in order to obtain a corrected current pressure value P_{c}.

The collecting unit 10 can recover the current oxygen pressure values P_{oxy} of each of the oxygen bottles 1 from a database 9 DB (DB for “database”) in which the current oxygen pressure values P_{oxy} of each of the oxygen bottles 1 are stored.

According to one embodiment, each of the oxygen bottles 1 comprises a pressure sensor C connected to the database 9. The collecting unit 10 thus collects the current oxygen pressure values P_{oxy} of each of the oxygen bottles 1 from the database 9.

In another embodiment, an operator inputs, using an input device, the current oxygen pressure values P_{oxy} read on each of the oxygen bottles 1 in order for them to be stored in the database 9.

The collecting unit 10 is also configured to correct the current oxygen pressure value P_{oxy} of each of the oxygen bottles 1.

The corrected current pressure value P_{c} is obtained by the collecting unit 10 based on the current oxygen pressure value P_{oxy}, based on a current temperature Tₐᵢᵣ (in ° C.) outside of the aircraft AC and a current temperature of the cockpit T_{cockpit} (in ° C.) of the aircraft AC. The current temperature of the cockpit T_{cockpit} of the aircraft AC can correspond to a temperature measured in the cockpit or to a temperature measured in an air mixer of an air-conditioning system in the cockpit.

The relationship by which the corrected current pressure value P_{c} can be obtained can correspond to the following equation:

$${P}_{c} = {P}_{oxy} \times \frac{273}{273 + \frac{{T}_{air} + {T}_{cockpit}}{2}}$$

The first estimating unit 20 is configured to estimate an average degradation model based on pressure values collected and corrected on a fleet comprising a predetermined number of aircraft AC.

The degradation model can correspond to a predictive model. For example, the degradation model can be estimated based on the fleet comprising a predetermined number of aircraft AC by adjusting a polynomial curve to the pressure values collected on the fleet of aircraft AC.

The adapting unit 40 is configured to adapt the average degradation model based on the corrected current pressure value P_{c} and on collected and corrected oxygen pressure values P_{ci} for X preceding flights. X is a predetermined number of flights preceding the current flight. The previously collected and corrected oxygen pressure values P_{ci} for X preceding flights correspond to oxygen pressure values collected and corrected for X preceding flights.

In a nonlimiting manner, the predetermined number (natural integer) X of preceding flights is greater than or equal to 5, advantageously greater than or equal to 10. As a nonlimiting example, the predetermined number X of preceding flights lies between 5 and 15. For example, the predetermined number X of preceding flights is equal to 8.

The generating unit 50 is configured to generate several future degradation scenarios based on the corrected current pressure value P_{c} and on the collected and corrected oxygen pressure values P_{ci} of the X preceding flights.

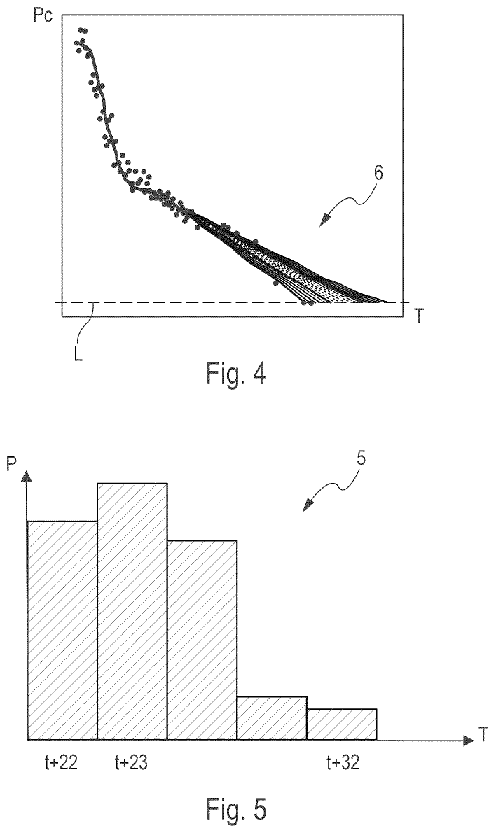

FIG. 4 represents the collected and corrected oxygen pressure values P_{ci} for X preceding flights on which several curves 6 are added. Each of the curves 6 is determined for a future degradation scenario using the average degradation model.

The second estimating unit 60 is configured to estimate, for each of

the future degradation scenarios, a remaining useful lifetime, and to generate a remaining useful lifetimes probability distribution 5 based on remaining useful lifetimes generated for each of the future degradation scenarios.

FIG. 4 shows a desired minimum useful pressure L. The remaining useful lifetime for each scenario corresponds to the useful lifetime for the desired minimum useful pressure.

FIG. 5 represents an example of remaining useful lifetimes

probability distribution 5. This remaining useful lifetimes probability distribution 5 corresponds to a time window which gives the possibility for an airline to predict and adapt the maintenance. In the example of FIG. 5, the filling of the oxygen bottle 1 should be done between the day t+22 and the day t+32. The airline can decide that the filling of the oxygen bottle can be done at t+30 and not at t+22.

The first transmitting unit 70 is configured to transmit an end-of-lifetime alert signal to an alert device 3 to alert an operator if a remaining useful lifetime of one or more oxygen bottles 1 is below an alert threshold predetermined as a function of the remaining useful lifetimes probability distribution 5. The alert signal can indicate which oxygen bottle 1 has a remaining useful lifetime below the predetermined alert threshold. The predetermined alert threshold can be defined by the airline which manages the aircraft AC.

For example, the alert device 3 corresponds to a display device configured to display an end-of-lifetime alert based on the end-of-lifetime alert signal transmitted by the first transmitting unit 70.

Advantageously, the system S further comprises a filtering unit 30, configured to filter the corrected current pressure value P_{c} and the collected and corrected oxygen pressure values P_{ci} of the X preceding flights and to determine a trend Tᵢ of the oxygen pressure value for the current flight and the X preceding flights. The filtering unit is implemented by the computer.

The filtering unit 30 can implement a Hodrick-Prescott filter known to the person skilled in the art.

In addition, the adapting unit 40 can further comprise a first computing sub-unit 410 COMPUT1 (COMPUT for “computing sub-unit”). The computing sub-unit 410 is configured to calculate a pressure variation (ΔPᵢ) for the current flight and for the X preceding flights based on the trend (Tᵢ) of the oxygen pressure value determined for the current flight and the X preceding flights.

The relationship by which the pressure variation ΔPᵢ can be obtained for the current flight can correspond to the following equation:

$$Δ {P}_{i} = \frac{{\sum }_{i} ( {Fn}_{i} - \overline{Fn} ) ( {T}_{i} - \overline{T} )}{{\sum }_{i} {( {Fn}_{i} - \overline{Fn} )}^{2}}$$

in which:
Fnᵢ corresponds to an index of the flight, thus Fnᵢ=i,
F̅n̅ corresponds to the average of the indices Fnᵢ for the predetermined number of preceding flights,
Tᵢ corresponds to the trend Tᵢ of the oxygen pressure value for the flight i of the X preceding flights,
T̅ corresponds to the average of the trends Tᵢ for the predetermined

number X of preceding flights.

The adapting unit 40 can further comprise:
a computing sub-unit 420 COMPUT2,
a comparing sub-unit 430 COMP (COMP for “comparing unit”) and
a compensating sub-unit 440 COMPENS (COMPENS for “compensating unit”).

The computing sub-unit 420 is configured to calculate a current expected pressure value P_{cepi} for the current flight and an expected pressure value P_{cepi} for the X preceding flights based on the collected and corrected oxygen pressure values P_{ci-1} determined for the X preceding flights and on pressure variations ΔPᵢ₋₁ determined for the X preceding flights.

The current expected pressure value P_{cepi}can be determined using the following expression: P_{cepi}=ΔPᵢ₋₁·Fnᵢ+(P̅c̅c̅ᵢ̅₋̅₁̅−ΔPᵢ₋₁·F̅n̅ᵢ̅₋̅₁̅),
in which:
P_{cepi}corresponds to the current expected pressure value.

The comparing sub-unit 430 is configured to determine, for the current flight and for each of the X preceding flights, respectively, a difference P_{cdifi} between the corrected pressure value P_{ci} and the expected pressure value P_{cepi}.

The expression of the difference is as follows: P_{cdifi}=P_{ci}−P_{cepi},
in which:
P_{cdifi} corresponds to the difference for the flight i,
P_{ci} corresponds to the corrected pressure value for the flight i,
P_{cepi} corresponds to the expected pressure value for the flight i.

The compensating sub-unit 440 is configured to compensate the corrected current pressure value P_{c} and the collected and corrected oxygen pressure values P_{ci} determined for the X preceding flights.

The previously collected and corrected oxygen pressure values are compensated as follows.

If the difference P_{cdifi} determined for the current flight or at least one of the X preceding flights is positive and exceeds a first threshold value OxyRT, the collected and corrected oxygen pressure values P_{ci} for the X preceding flights are compensated by adding the difference P_{cdifi} to the collected and corrected oxygen pressure values P_{ci} for the X preceding flights. That corresponds to an increase in the oxygen pressure in the oxygen bottle 1. That increase can correspond to a filling of the oxygen bottle 1 or a replacement of the oxygen bottle with another full oxygen bottle.

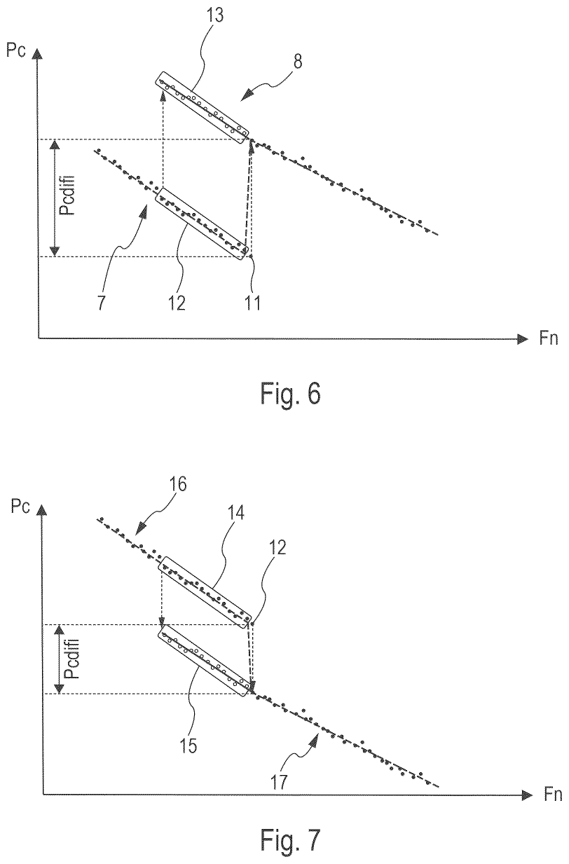

FIG. 6 represents a curve 7 of the oxygen pressure values collected and corrected before a filling of the oxygen bottle 1 with oxygen. At the point 11, called filling point, the collected and corrected oxygen pressure values P_{ci} surrounded by the frame 12 are compensated as explained above. The curve 8 corresponds to the curve of the oxygen pressure values collected and corrected after a filling of the oxygen bottle 1 with oxygen. The oxygen pressure values collected and corrected before the filling of the X preceding flights (surrounded by the frame 13) are also included in the curve 8 after the compensation.

If the difference P_{cdifi} determined for the current flight or at least one of the X preceding flights is negative and exceeds a second threshold value OxyDT, the collected and corrected oxygen pressure values P_{ci} for the X preceding flights are compensated by adding the difference P_{cdifi} (which is negative) to the collected and corrected oxygen pressure values P_{ci} for the X preceding flights. This condition corresponds to a pressure drop in the oxygen bottle 1.

FIG. 7 represents a curve 16 of the oxygen pressure values collected and corrected before the oxygen pressure drop of the oxygen bottle 1. At the point 12, called drop point, the collected and corrected oxygen pressure values P_{ci} surrounded by the frame 14 are compensated as explained above. The curve 17 corresponds to the curve of the oxygen pressure values collected and corrected after the pressure drop of the oxygen bottle 1. The oxygen pressure values collected and corrected before the pressure drop of the X preceding flights (surrounded by the frame 15) are also included in the curve 17 after the compensation.

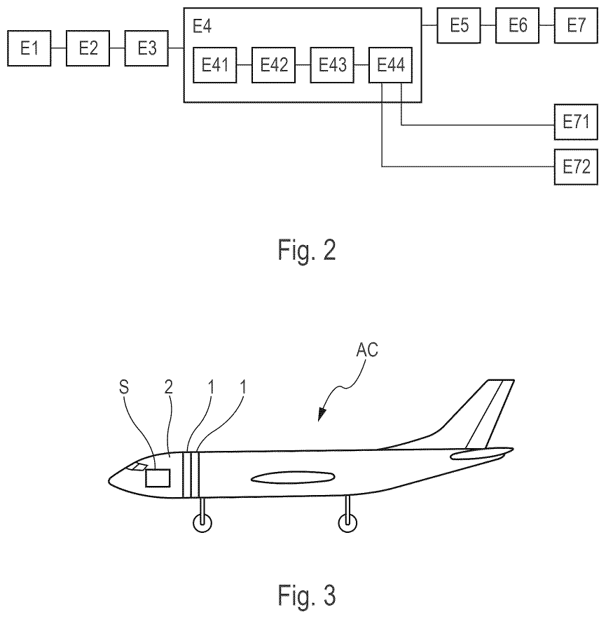

The system S can further comprise a second transmitting unit 71, configured to transmit a pressure drop alert signal to the alert device 3 if a flight of the aircraft AC out of the current flight and the X preceding flights has, for its departure airport, the same arrival airport as the flight which precedes it, in the case where the difference P_{cdifi} determined for the current flight or at least one of the X preceding flights is negative and exceeds a second threshold value OxyDT.
The system S can comprise a third transmitting unit 72, configured to transmit a leak alert signal to the alert device 3, in the case where the difference P_{cdifi} determined for the current flight or at least one of the X preceding flights is below a third threshold value OxyLT1.
The disclosure herein also relates to a method for automatically estimating a remaining useful lifetime of at least one oxygen bottle 1 in a cockpit 2 of an aircraft AC (FIG. 2).

The method comprises at least the following steps implemented for a current flight of the aircraft AC iteratively for each oxygen bottle 1:
a collection step E1, implemented by the collecting unit 10, for collecting a current oxygen pressure value P_{oxy} of the oxygen bottle or bottles 1 and for correcting the current oxygen pressure value P_{oxy} in order to obtain a corrected current pressure value P_{c},
a first estimation step E2, implemented by the first estimating unit 20, for estimating an average degradation model based on pressure values collected and corrected on a fleet comprising a predetermined number of aircraft,
an adaptation step E4, implemented by the adapting unit 40, for adapting the average degradation model based on the corrected current pressure value P_{c} and on oxygen pressure values collected and corrected previously P_{ci} for X preceding flights, X being a predetermined number of flights preceding the current flight,
a generation step E5, implemented by the generating unit 50, for generating several future degradation scenarios based on the corrected current pressure value P_{c} and on the collected and corrected oxygen pressure values P_{ci} of the X preceding flights,
a second estimation step E6, implemented by the second estimating unit 60, for estimating, for each of the future degradation scenarios, a remaining useful lifetime, and for generating a remaining useful lifetimes probability distribution 5 based on the remaining useful lifetimes generated for each of the future degradation scenarios,
a first transmission step E7, implemented by the first transmitting unit 70, for transmitting an end-of-lifetime alert signal to an alert device 3 to alert an operator if a remaining useful lifetime of one or more oxygen bottles 1 is below an alert threshold predetermined as a function of the remaining useful lifetimes probability distribution 5.

The method can comprise a filtering step E3 preceding the adaptation step E4, implemented by the filtering unit 30, for filtering the corrected current pressure value P_{c} and the collected and corrected oxygen pressure values P_{ci} of the X preceding flights and for determining a trend Tᵢ of the oxygen pressure value for the current flight and the X preceding flights.

The adaptation step E4 can further comprise a computation sub-step E41, implemented by the computing sub-unit 410, for calculating a pressure variation ΔPᵢ for the current flight and for the X preceding flights based on the trend Tᵢ of the oxygen pressure value determined for the current flight and the X preceding flights.

The adaptation step E4 can further comprise:
a computation sub-step E42, implemented by the computing sub-unit 420, for calculating a current expected pressure value P_{cepi} for the current flight and an expected pressure value P_{cepi}for the X preceding flights based on the collected and corrected oxygen pressure values P_{ci-1} determined for the X preceding flights and on pressure variations ΔPᵢ₋₁ determined for the X preceding flights,
a comparison sub-step E43, implemented by the comparing sub-unit 430, for determining, for the current flight and for each of the X preceding flights, respectively, a difference P_{cdifi} between the corrected pressure value P_{ci} and the expected pressure value P_{cepi},
a compensation sub-step E44, implemented by the compensating sub-unit 440, for compensating the corrected current pressure value P_{c} and the collected and corrected oxygen pressure values P_{ci} determined for the X preceding flights.

The method can further comprise a second transmission step E71, implemented by the second transmitting unit 71, for transmitting a pressure drop alert signal to the alert device 3 if a flight of the aircraft AC out of the current flight and the X preceding flights has, for its departure airport, the same arrival airport as the flight which precedes it, in the case where the difference P_{cdifi} determined for the current flight or at least one of the X preceding flights is negative and exceeds a second threshold value OxyDT.

The method can comprise a third transmission step E72, implemented by the third transmitting unit 72, for transmitting a leak alert signal to the alert device 3, in the case where the difference P_{cdifi} determined for the current flight or at least one of the X preceding flights is below a third threshold value OxyLT1.

The system S and the method offer at least the following advantages:

Proposing a decision aid tool with quantifiable uncertainty for alerting or not as to the replacement of an oxygen bottle 1 with a controlled level of risk, namely:
A better management of the spare parts,
A better management of the life cycle of an oxygen bottle 1,

The method uses a predesigned model augmented by the use of in-service data.

The method requires little historical data and a partial knowledge of the degradation.

While at least one example embodiment of the invention(s) is disclosed herein, it should be understood that modifications, substitutions, and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for automatically estimating a remaining useful lifetime of at least one oxygen bottle in a cockpit of an aircraft, the method comprising at least steps as follow implemented for a current flight of the aircraft iteratively for each oxygen bottle:
a collection step, implemented by a collecting unit, for collecting a current oxygen pressure value of the oxygen bottle or bottles and for correcting the current oxygen pressure value in order to obtain a corrected current pressure value;
a first estimation step, implemented by a first estimating unit, for estimating an average degradation model based on pressure values collected and corrected on a fleet comprising a predetermined number of aircraft;
an adaptation step, implemented by an adapting unit, for adapting the average degradation model based on the corrected current pressure value and on previously collected and corrected oxygen pressure values for X preceding flights, X being a predetermined number of flights preceding the current flight;
a generation step, implemented by a generating unit, for generating several future degradation scenarios based on the corrected current pressure value and on the collected and corrected oxygen pressure values) of the X preceding flights;
a second estimation step, implemented by a second estimating unit, for estimating, for each of the future degradation scenarios, a remaining useful lifetime, and for generating a remaining useful lifetimes probability distribution based on the remaining useful lifetimes generated for each of the future degradation scenarios; and
a first transmission step, implemented by a first transmitting unit, for transmitting an end-of-lifetime alert signal to an alert device to alert an operator if a remaining useful lifetime of one or more oxygen bottles is below an alert threshold predetermined as a function of the remaining useful lifetimes probability distribution.

2. The method according to claim 1, wherein the corrected current pressure value is obtained in the collection step based on the current oxygen pressure value, based on a current temperature outside of the aircraft and a current temperature of the cockpit of the aircraft.

3. The method according to claim 1, comprising a filtering step preceding the adaptation step, implemented by a filtering unit, for filtering the corrected current pressure value and the collected and corrected oxygen pressure values of the X preceding flights and for determining a trend of the oxygen pressure value for the current flight and the X preceding flights.

4. The method according to claim 1, wherein the adaptation step further comprises a computation sub-step, implemented by a computing sub-unit, for calculating a pressure variation for the current flight and for the X preceding flights based on a trend of the oxygen pressure value determined for the current flight and the X preceding flights.

5. The method according to claim 1, wherein the adaptation step comprises:
a computation sub-step, implemented by a computing sub-unit, for calculating a current expected pressure value for the current flight and an expected pressure value for the X preceding flights based on the collected and corrected oxygen pressure values determined for the X preceding flights and on pressure variations determined for the X preceding flights;
a comparison sub-step, implemented by a comparing sub-unit, for determining, for the current flight and for each of the X preceding flights, respectively, a difference between the corrected pressure value and the expected pressure value;
a compensation sub-step, implemented by a compensating sub-unit, for compensating the corrected current pressure value and the collected and corrected oxygen pressure values determined for the X preceding flights;
if the difference determined for the current flight or at least one of the X preceding flights is positive and exceeds a first threshold value, the collected and corrected oxygen pressure values for the X preceding flights being compensated by adding the difference to the collected and corrected oxygen pressure values for the X preceding flights,
if the difference determined for the current flight or at least one of the X preceding flights is negative and exceeds a second threshold value, the collected and corrected oxygen pressure values for the X preceding flights being compensated by adding the difference to the collected and corrected oxygen pressure values for the X preceding flights.

6. The method according to claim 5, comprising a second transmission step, implemented by a second transmitting unit, for transmitting a pressure drop alert signal to the alert device if a flight of the aircraft out of the current flight and the X preceding flights has, for its departure airport, a same arrival airport as the flight which precedes it, in a case where the difference determined for the current flight or at least one of the X preceding flights is negative and exceeds a second threshold value.

7. The method according to claim 5, comprising a third transmission step, implemented by a third transmitting unit, for transmitting a leak alert signal to the alert device, in a case where the difference determined for the current flight or at least one of the X preceding flights is below a third threshold value.

8. A system for automatically estimating a remaining useful lifetime of at least one oxygen bottle in a cockpit of an aircraft, the system comprising at least:
a collecting unit, configured to collect a current oxygen pressure value of the oxygen bottle or bottles and to correct the current oxygen pressure value in order to obtain a corrected current pressure value;
a first estimating unit, configured to estimate an average degradation model based on pressure values collected and corrected on a fleet comprising a predetermined number of aircraft;
an adapting unit, configured to adapt the average degradation model based on the corrected current pressure value and on collected and corrected oxygen pressure values for X preceding flights, X being a predetermined number of flights preceding the current flight;
a generating unit, configured to generate several future degradation scenarios based on the corrected current pressure value and on the collected and corrected oxygen pressure values of the X preceding flights;
a second estimating unit, configured to estimate, for each of the future degradation scenarios, a remaining useful lifetime, and to generate a remaining useful lifetimes probability distribution based on the remaining useful lifetimes generated for each of the future degradation scenarios; and
a first transmitting unit configured to transmit an end-of-lifetime alert signal to an alert device to alert an operator if a remaining useful lifetime of one or more oxygen bottles is below an alert threshold predetermined as a function of the remaining useful lifetimes probability distribution.

9. The system according to claim 8, wherein the corrected current pressure value is obtained by the collecting unit based on the current oxygen pressure value, based on a current temperature outside of the aircraft and a current temperature of the cockpit of the aircraft.

10. The system according to claim 8, comprising a filtering unit, configured to filter the corrected current pressure value and the collected and corrected oxygen pressure values (P_{ci}) of the X preceding flights and to determine a trend of the oxygen pressure value for the current flight and the X preceding flights.

11. The system according to claim 8, wherein the adapting unit comprises a computing sub-unit, configured to calculate a pressure variation for the current flight and for the X preceding flights based on the trend of the oxygen pressure value determined for the current flight and the X preceding flights.

12. The system according to claim 8, wherein the adapting unit comprises:
a determining sub-unit, configured to determine a current expected pressure value for the current flight and an expected pressure value for the X preceding flights based on the collected and corrected oxygen pressure values determined for the X preceding flights and on pressure variations determined for the X preceding flights;
a comparing sub-unit, configured to determine, for the current flight and for each of the X preceding flights, respectively, a difference between the corrected pressure value and the expected pressure value;
a compensating sub-unit, configured to compensate the corrected current pressure value and the collected and corrected oxygen pressure values determined for the X preceding flights;
if the difference determined for the current flight or at least one of the X preceding flights is positive and exceeds a first threshold value, the collected and corrected oxygen pressure values for the X preceding flights being compensated by adding the difference to the collected and corrected oxygen pressure values for the X preceding flights,
if the difference determined for the current flight or at least one of the X preceding flights is negative and exceeds a second threshold value, the collected and corrected oxygen pressure values for the X preceding flights being compensated by adding the difference to the collected and corrected oxygen pressure values for the X preceding flights.

13. The system according to claim 12, comprising a second transmitting unit, configured to transmit a pressure drop alert signal to the alert device if a flight of the aircraft out of the current flight and the X preceding flights has, for its departure airport, a same arrival airport as the flight which precedes it, in the case where the difference determined for the current flight or at least one of the X preceding flights is negative and exceeds a second threshold value.

14. The system according to claim 12, comprising a third transmitting unit, configured to transmit a leak alert signal to the alert device, in the case where the difference determined for the current flight or at least one of the X preceding flights is below a third threshold value.

15. An aircraft comprising the system of claim 8.
